(19) United States
(12) Patent Application Publication
(10) Pub. No.: US 2013/0192423 A1
(43) Pub. Date: Aug. 1, 2013

(54) METHOD OF PRODUCING SILVER NANOWIRES

(71) Applicants: Huajing Yang, Jinan (CN); Juanjuan Zhang, Jinan (CN); Chaohao Hou, Jinan (CN)

(72) Inventors: Huajing Yang, Jinan (CN); Juanjuan Zhang, Jinan (CN); Chaohao Hou, Jinan (CN)

(73) Assignee: Blue Nano Inc.

(21) Appl. No.: 13/359,778

(22) Filed: Jan. 27, 2012

(51) Int. Cl. B22F 9/24; B82Y 40/00

(52) U.S. Cl. 75/370; 977/896

(57) ABSTRACT

A method for the production of silver nanowire comprising the steps of: heating a first solution comprising a polyol and a salt; adding a second solution comprising a polyol and a silver nitrate; adding a third solution comprising a polyol and an organic polymer as a template carrier creating a combined solution; stirring the combined solution at an elevated temperature for a time period followed by cooling the combined solution; and washing the combined solution and isolating the silver nanowires.

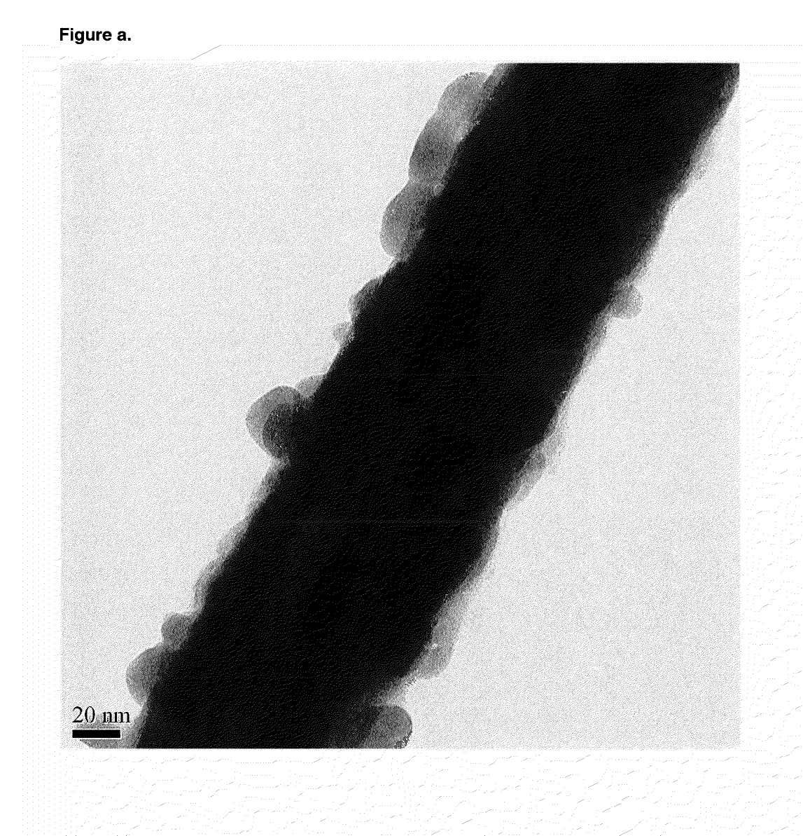

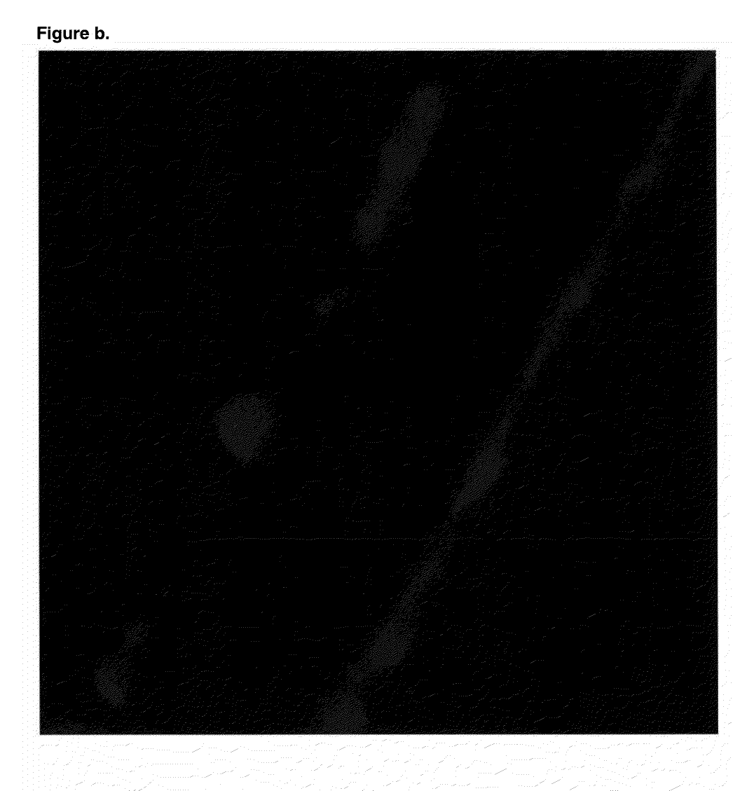

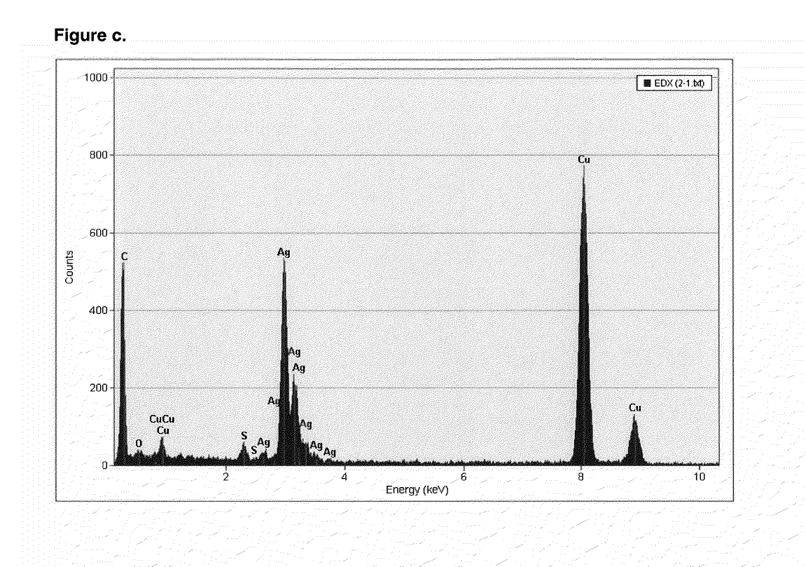

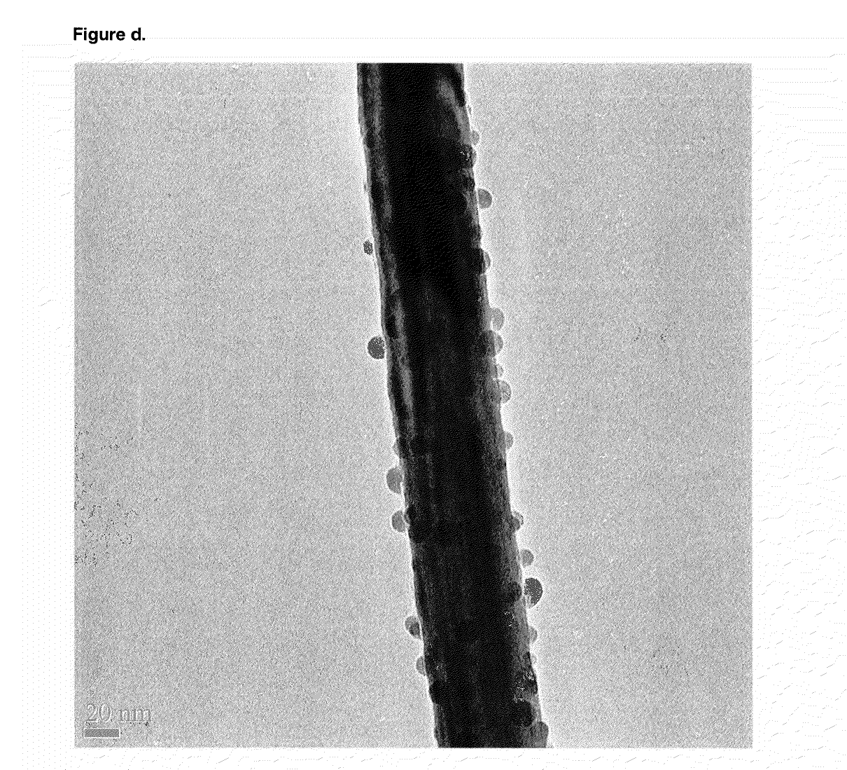

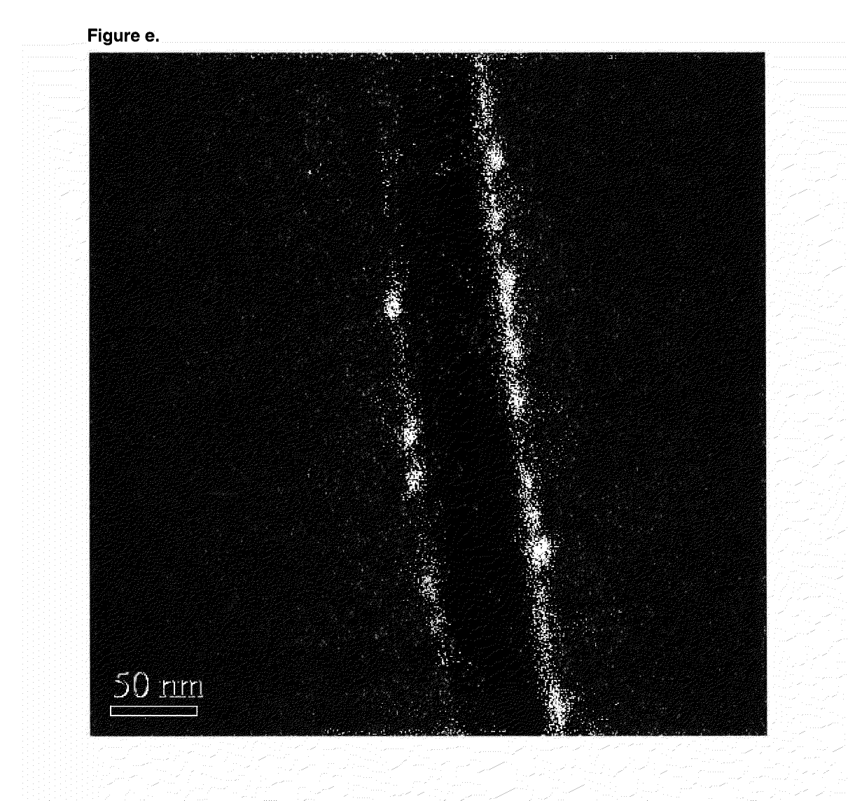

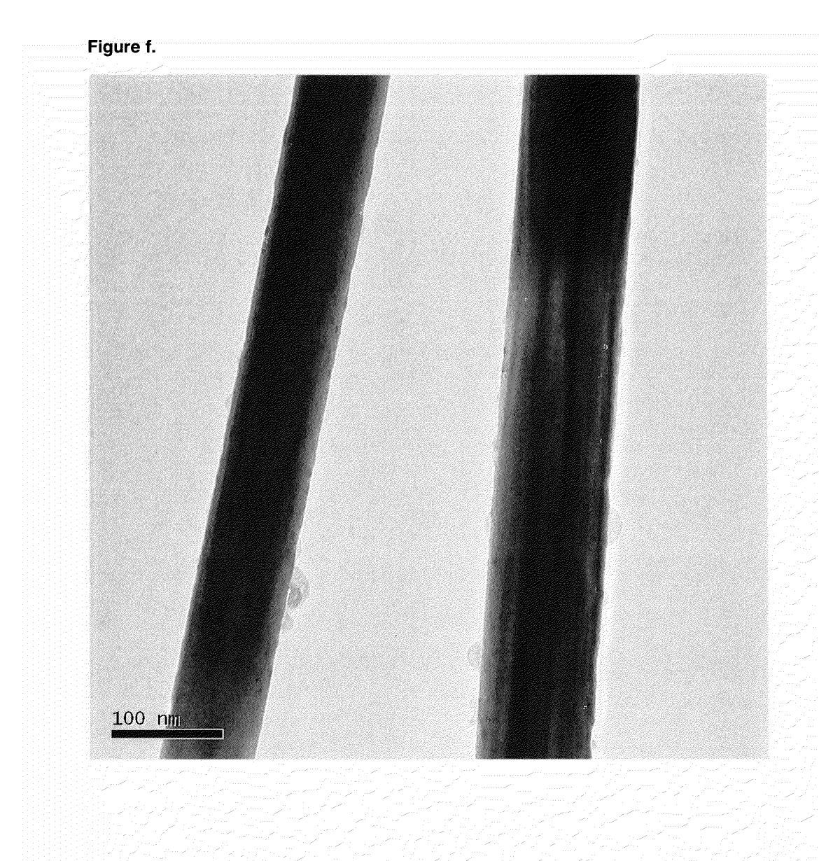

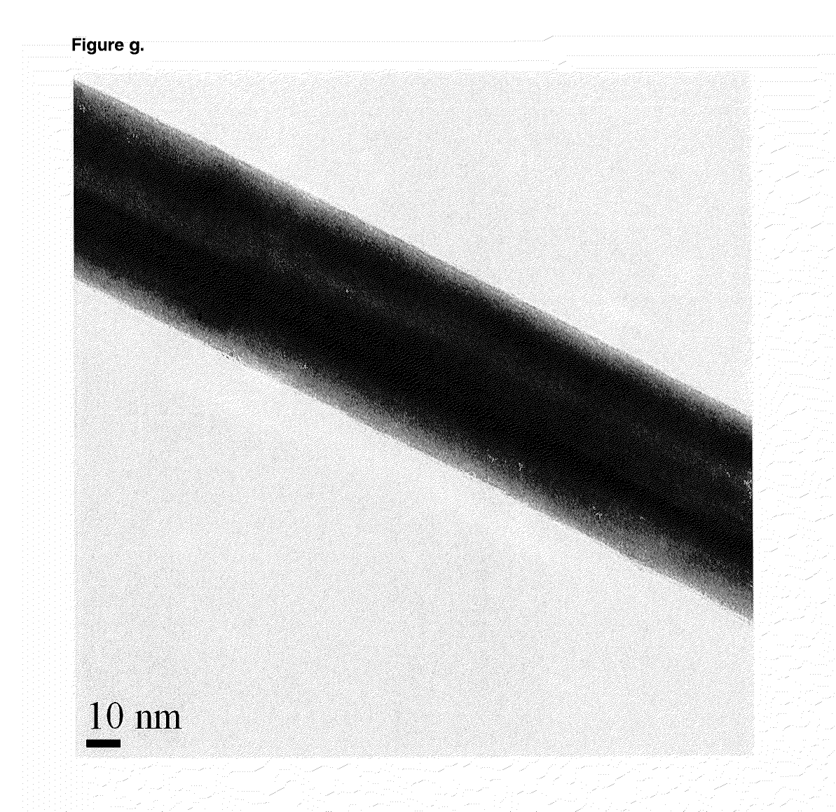

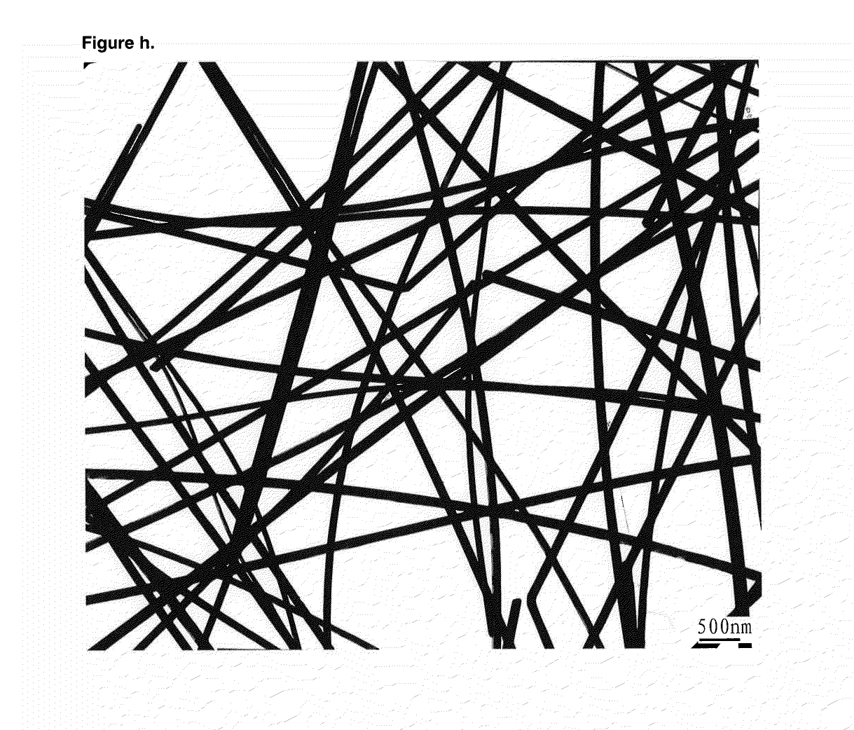

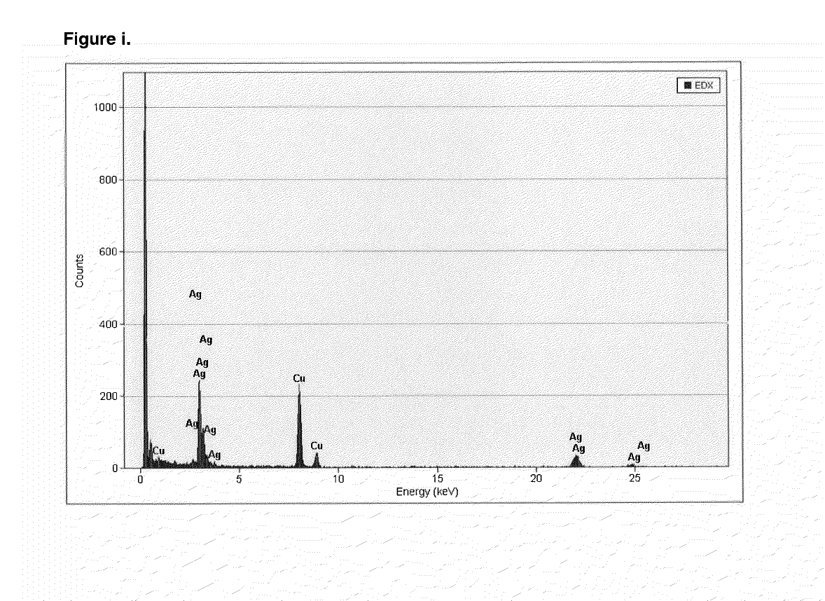

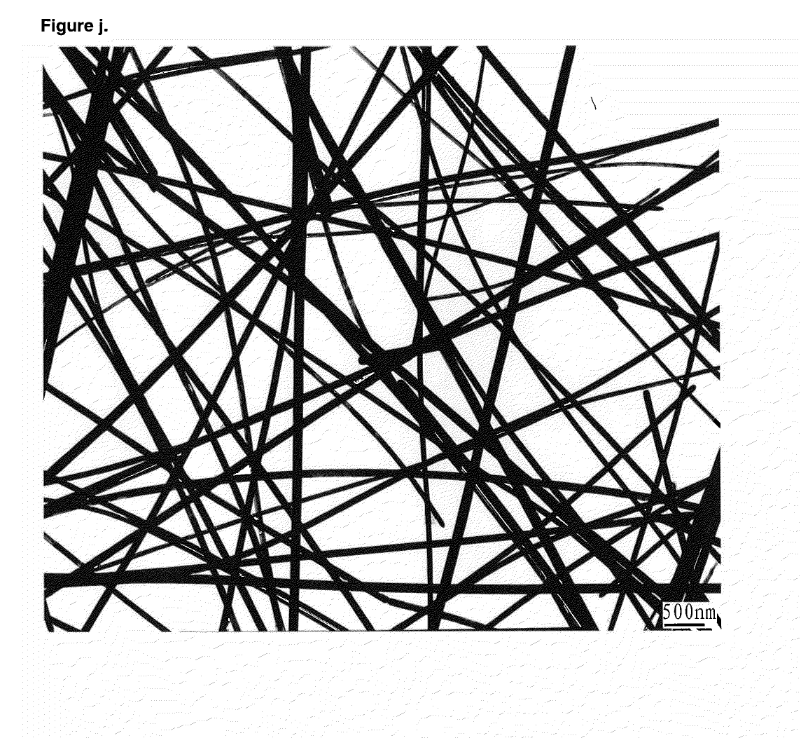

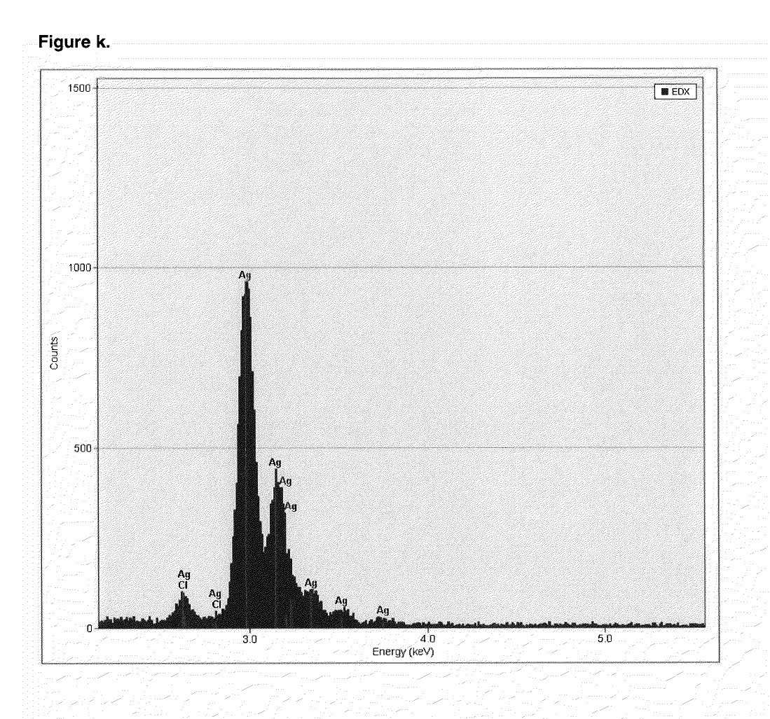

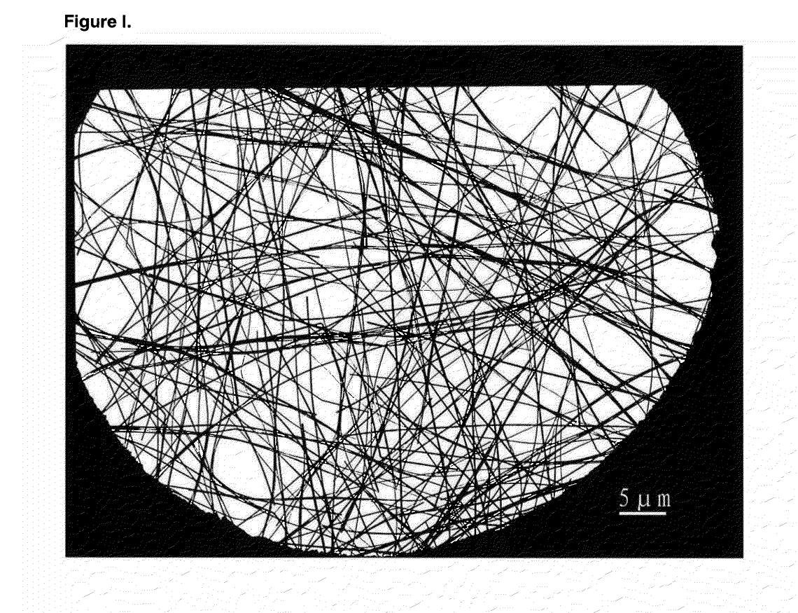

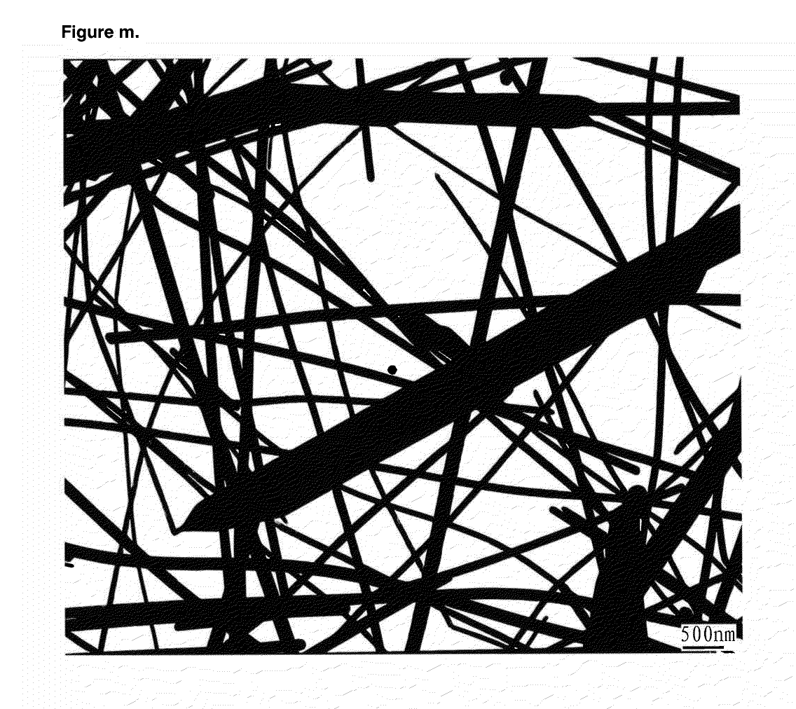

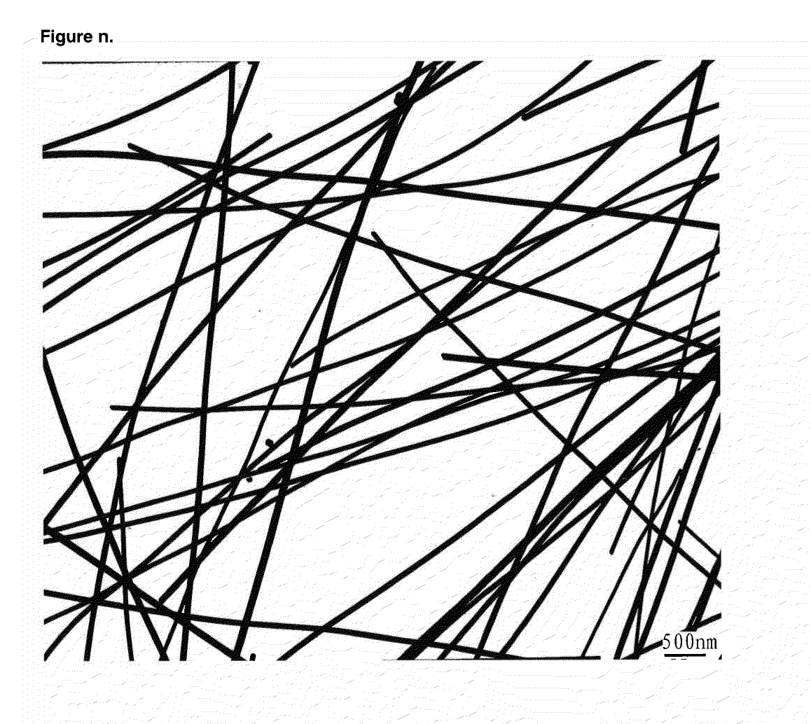

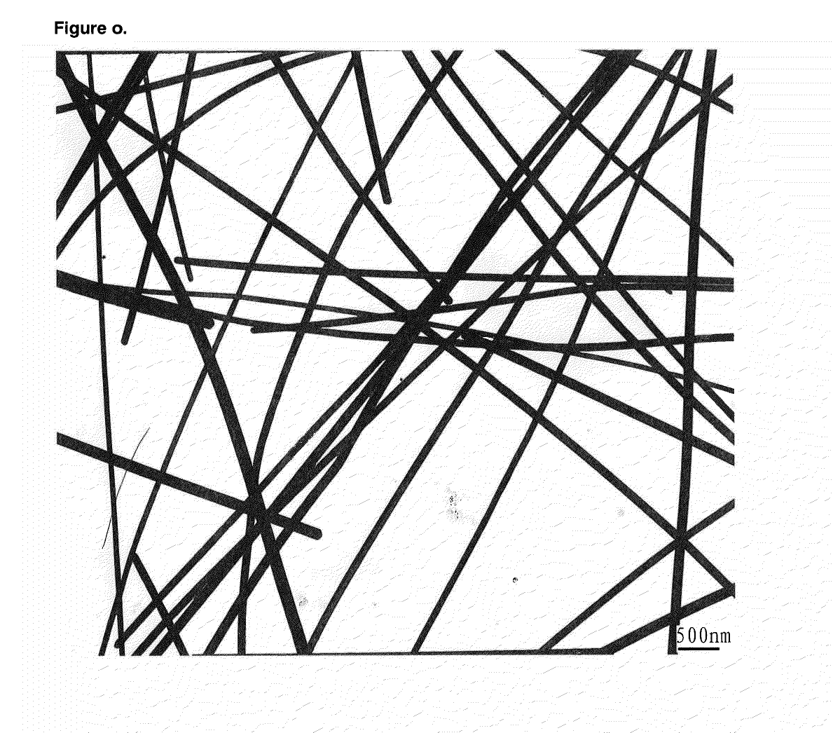

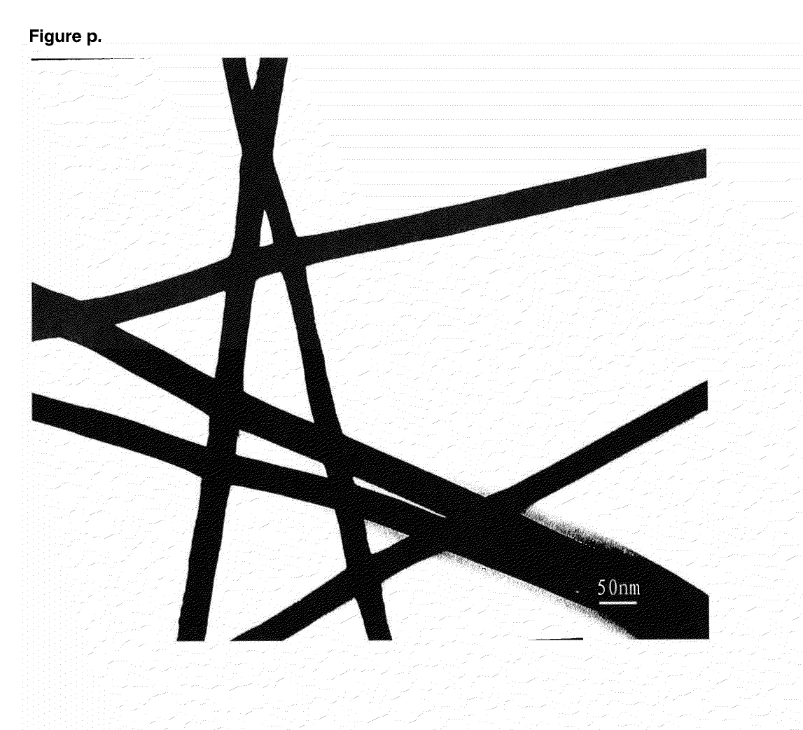

### FIELD OF THE INVENTION

The invention relates to the field of nanotechnology, and more specifically relates to methods for the synthesis of high quality silver nanowires.

### BACKGROUND OF THE INVENTION

Nano-materials refer to the materials having two dimensions with the sizes at 1˜100 nm. One-dimensional nanostructures of metal exhibit unique magnetic, electrical, optical, and thermal properties, as well as their interesting applications in microelectronics and biological devices. Among the metals, silver nanowire has got significant amount of research attention because of its high electrical and thermal conductivities. It has been used in many applications, such as optical polarizers, photonic crystals, catalysts, microelectronics, and surface enhanced Raman scattering (SERS). Particularly, silver nanowire is used in transparent electrodes (U.S. patent 20110024159 and Adv. Mater., 2011, 23, 4453-4457), thermal conductive silicone grease and other electronic devices (U.S. patent 20090269604). Silver nanowire can be used as conductive media in many applications, for example, a network of silver nanowires impart both high electrical conductance and high optical transmittance, which makes it a suitable material for fabricating transparent conductors. Especially, the transparent electrode using silver nanowire is a good alternative solution for ITO-based electrode because of its high performance and low cost.

In the last decades, different approaches have been used to synthesize silver nanowires. The most widely used methods for generating silver nanowires are various chemical routes, such as the polyol process, the wet chemical synthesis, the hydrothermal method, the ultraviolet irradiation photo reduction technique, the electrochemical technique, the DNA-template method, and the porous-materials-template method. Among these methods, the polyol process is an effective route to synthesize silver nanowires. The polyol process involves the reduction of silver nitrate by polyol in the presence of template carrier, but this process is very sensitive to impurities in raw materials or the contamination in the environment, particularly sulfide-related chemicals introduced into the reactors or the product storages can corrode silver nanowires and thus reduce the electrical conductance and the stability of the produce. Methods for producing high quality silver nanowires that resist the presence of impurities are very interesting and important for the commercial manufacture and application. The high quality nanowires have large market demands.

Additional aspects and advantages of this invention will be apparent from the following detailed description of preferred embodiments, which proceeds with reference to the accompanying drawings.

### SUMMARY OF THE INVENTION

A method for the production of silver nanowire comprising the steps of: heating a first solution comprising a polyol and a salt; adding a second solution comprising a polyol and a silver nitrate; adding a third solution comprising a polyol and an organic polymer as a template carrier creating a combined solution; stirring the combined solution at an elevated temperature for a time period followed by cooling the combined solution; and washing the combined solution and isolating the silver nanowires.

### BRIEF DESCRIPTION OF THE DRAWINGS

Figure (a) is a Transmission Electron Microscopy (TEM) picture of a silver nanowire produced using a polyol process without the addition of NCS.

Figure (b) is a sulfur map of figure (a) using Energy Filtered Transmission Electron Microscopy (EFTEM).

Figure (c) is a spectrogram of one small zone of figure (a).

Figure (d) is a TEM picture of a silver nanowire produced using a polyol process including an addition of 10 μM of NCS.

Figure (e) is a sulfur map of figure (d) using EFTEM.

Figure (f) is a TEM picture of a silver nanowire produced using a polyol process including an addition of 100 μM of NCS.

Figure (g) is a TEM picture of a silver nanowire produced using a polyol process including an addition of 300 μM of NCS.

Figure (h) is a TEM picture of a silver nanowire produced using a polyol process including an addition of 0.01 M of copper nitrate.

Figure (i) is a spectrogram of one small zone of figure (h).

Figure (j) is a TEM pictures of a silver nanowire produced using a polyol process including an addition of ethanethiol.

Figure (k) is a spectrogram of one small zone of figure (j).

Figure (l) is a TEM pictures of a silver nanowire produced using a polyol process including an addition of ethanethiol.

Figure (m) is a TEM picture of a silver nanowire produced using a polyol process without the addition of a high-valence metal ion.

Figure (n) is a TEM picture of a silver nanowire produced using a polyol process including an addition of 80 μM of Fe(NO₃)₃.

Figure (o) is a TEM picture of a silver nanowire produced using a polyol process including an addition of 100 μM of Mg(NO₃)₂.

Figure (p) is a TEM picture of a silver nanowire produced using a polyol process including an addition of an AgCl solution and nitric acid.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Over the past decade, various methods have been reported to prepare silver nanostructures with controllable morphologies. In these methods, the polyol process was an effective and impressive way to synthesize 1D silver nanowires, but this process is very sensitive to impurities in raw materials and the environment. Particularly the presence of the sulfide-related chemicals can reduce the quality and the stability of the silver nanowires through the corrosion.

In the polyol process, sulfides present in the raw materials and the environment will react with silver nanowires. Silver nanowires absorbing silver sulfide onto their surfaces make it very easy for the nanowire to become corroded and thus reduce the stability of the nanowire. One method to overcome this problem is with inert gas protection, but with a significant increase in cost and complexity of the manufacturing process. The instant invention discloses several cost effective methods to reduce the sulfide corrosion-effect and supply high quality silver nanowire products with a uniform particle size distribution and a high aspect ratio.

This invention discloses a way of adding an anti-sulfide agent, a noble metal salt, and/or a sulfhydryl-containing aliphatic compound to solve the sulfur contamination problem. This invention also discloses some other ways of adding high-valence metal ions, silver chloride and acid compounds during the polyol process to get high quality silver nanowires with a uniform particle size distribution and a high aspect ratio.

Several kinds of synthesis methods for high quality silver nanowire by adaptation of the polyol process are disclosed by the instant invention. In some embodiments an anti-sulfur agent is added to the reaction to ease the adversely affect of sulfide in raw materials. In some embodiments a noble metal salt is added to the reaction to form alloy with silver. In some embodiments a sulfhydryl-containing aliphatic compound is added to the later period of the polyol process. In some embodiments, in order to obtain uniform size distribution, high-valence metal ions are added to the reaction. In some embodiments, exotic seeds and an acid compound are added to the reaction and the process reacted in a consistent temperature condition.

One embodiment of the instant invention discloses a method for the production of silver nanowire comprising the steps of: heating a first solution comprising a polyol and a salt; adding a second solution comprising a polyol and a silver nitrate; adding a third solution comprising a polyol and an organic polymer as a template carrier creating a combined solution; stirring the combined solution at an elevated temperature for a time period followed by cooling the combined solution; and washing the combined solution and isolating the silver nanowires.

Another embodiment of the instant invention discloses a method for the production of silver nanowire comprising the steps of: a first seeding step including heating a first solution comprising a polyol, a salt and an organic polymer as a template carrier; adding an acid followed by the addition of a silver chloride solution resulting in a second solution containing nano-seeds for initial nucleation; a second crystal growth step including heating the second solution to a temperature for a period of time to ensure growth of the silver nanowires from the nano-seeds; cooling the second solution; and washing the second solution and isolating the silver nanowires.

### Definitions

“Nanometer”, as used herein, refers to 10⁻⁹ meters and may be used interchangeably with its abbreviation “nm.”

“Nanoparticle”, as used herein, refers to a noble-metal particle having dimensions of from 1 to 5000 nanometers, having any size, shape or morphology. For use with the present invention the nanoparticles are noble metals, such as gold colloid or silver and may be, e.g., nanospheres, nanotubes, nanorods, nanocones, nanowires and the like. “Nanoparticle”, as used herein, refers to one or more nanoparticles. As used herein, “nanowire” means one or more nanowires.

“Polyol process” as used herein, refers to the process developed by Xia which is considered to be an excellent method for the shape-controlled synthesis of silver nanowires, using polyol as reducer and solvent and poly(vinylpyrrolidone) (PVP) as template carrier. The polyol process is well known by those in the art as a means to synthesize silver nanoparticles with controllable shapes in relatively large quantities. (See, e.g. Y. Sun, Y. Xia, Science 2002, 298, 2176; R. Jin, S. Egusa, N. F. Scherer, J. Am. Chem. Soc. 2004, 126, 9900; T. K. Sau, C. J. Murphy, J. Am. Chem. Soc. 2004, 126, 8648; F. Kim, S. Connor, H. Song, T. Kuykendall, P. Yang, Angew. Chem. Int. Ed. 2004, 43, 3673; Y. Sun, B. Mayers, Y. Xia, Nano. Lett. 2003, 5, 675; Y. Sun, B. Mayers, T. Herricks, Y. Xia, Nano Lett. 2003, 3, 955; Y. Sun, Y. Yin, B. Mayers, T. Herricks, Y. Xia, Chem. Mater. 2002, 14, 4736; and Y. Sun, B. Mayers, Y. Xia, Adv. Mater. 2003, 15, 641, each of which are incorporated in their entirety by reference herein).

Production of silver nanostructures by the polyol process is known (See for Example: Wiley et al., Shape—Controlled Synthesis of Metal Nanostructures The case of Silver, Chem. Eur. J., 11: 454-463 (2005) and Wiley et al., Polyol Synthesis of Silver Nanoparticles: Use of Chloride and Oxygen to Promote the Formation of Single—Crystal, Truncated Cubes and Tetrahedrons, Nano Letters, 4(9): 1733-1739 (2004)). The polyol process is a solution-based method in which a silver ion containing solution is created by mixing a silver compound in a polyol solvent. The silver compound can be an inorganic salt such as silver nitrate (AgNO₃) or an organic salt such as silver acetate (AgC₂H₃O₂). The silver compound is reduced to silver metal through the polyol process. In a typical polyol synthesis, silver atoms (which produce the metal that forms the nanostructures) may be obtained by reducing AgNO₃ with ethylene glycol (EG) through the following reactions:

2HOCH₂CH₂OH→2CH₃CHO+2H₂O (1)

2Ag⁺+2CH₃CHO→CH₃CHO—OHCCH₃+2Ag+2H⁺ (2)

The polyol serves as a solvent for the silver compound, a solvent for the reaction, and the reducing agent that reduces the silver compound to silver metal. Silver production is controlled by the rate of Ag(I) reduction, which increases with temperature (Ducamp-Sanguesa et al., Journal of Solid State Chemistry, 100: 272-280 (1992) at page 274, col. 2). Thus, the polyol process is typically practiced at elevated temperature although the reaction has been known to occur at ambient temperature in the presence of poly(vinyl pyrrolidone) (PVP) (See: Carotenuto et al., Eur. Phys. J. B, 16:11-17 (2000) at page 12, col. 2 and U.S. Published Patent Application No. US 2007/0034052 A1 to Vanheusden et al. published on Feb. 15, 2007 at paragraph 38).

“Silver nanowires” as used herein, refer to silver nanowires having little to no sulfide on their surfaces and which have a uniform particle size distribution and a high aspect ratio. In one embodiment of the present invention, the diameter of the silver nanowires may be in the range of 30 to 90 nm and the length of the silver nanowires may be in the range of 10 to 60 μm. The diameters of the silver nanowires can be about 30 nm, between 30 and 40 nm, between 40 and 50 nm, between 50 and 60 nm, between 60 and 70 nm, between 70 and 80 nm, between 80 and 90 nm, about 90 nm, or any combination thereof and the length of the silver nanowires can be about 10 μm, between 10 and 20 μm, between 20 and 30 μm, between 30 and 40 μm, between 40 and 50 μm, between 50 and 60 μm, about 60 μm or any combination thereof.

“Polyol” as used herein, refers to a material which is capable of reducing the silver compound to silver metal, thereby creating a silver solution, at the reaction temperature when present in the reaction mixture. The polyol may be a single polyol or a mixture of two or more polyols. In one embodiment of the present invention, a polyol is selected from the group comprising: ethylene glycol, 1,2-propylene glycol, 1,3-propylene glycol, glycerin, and glycerol, or a combination thereof.

“Salt” as used herein, refers to a compound formed when the hydrogen of an acid is replaced by a metal or its equivalent. Stated another way, the product of a reaction between an acid and a base which yields a salt and water. In one embodiment of the present invention, a salt is selected from the group comprising: sodium chloride, potassium chloride, sodium bromide, potassium bromide, sodium iodide, potassium iodide, lithium chloride, lithium bromide, lithium iodide, tetrabutylammonium chloride (TBAC), tetrabutyl ammonium bromide (TBAB), cetyltrimethyl Ammonium Bromide (CTAB), or a combination thereof.

“Organic polymer as a template carrier” as used herein, refers to a substance which acts to shield (e.g., sterically and/or through charge effects) the nanostructures and nanoparticles from each other to at least some extent and thereby reduce and/or prevent direct contact between individual nanostructures. (See Wang et al., U.S. 20090196788). In one embodiment of the present invention, a template carrier is selected from the group comprising: a polyvinylpyrrolidone (PVP), a polyvinyl alcohol (PVA), or a combination thereof.

“Elevated temperature” as used herein, refers to the temperature of the heat source applied to the reaction vessel or the actual temperature of the reaction mixture or reaction solution during the reaction as determined by direct monitoring. In one embodiment, the reaction temperature can be the temperature of an oil bath used to heat the vessel containing all the reactants of a polyol process or could be the temperature of the reaction mixture as determined by a thermometer or thermocouple inserted into the reaction mixture/solution.

“Consistent temperature condition” or “constant temperature condition” refers to the condition wherein the polyol process is carried out at consistent/constant temperature. The temperature of the part of the flask immersed in the oil and exposed to the cool air cannot have a consistent temperature unless the flask is wholly immersed in the oil. The reaction described by the instant invention is very sensitive to the temperature, so a consistent temperature condition is very necessary for the synthesis of high quality nanowires. The conditions include, but are not limited to: hot oil with a consistent temperature, hot air with a consistent temperature, hot nitrogen with a consistent temperature, or a combination thereof.

“Anti-sulfur agent/anti-sulfide agent” as used herein, refers to a substance which offers some level of protection against sulfur or sulfides. An anti-sulfur agent/anti-sulfide agent helps to minimize or prevent completely the deposition or contamination of nanoparticles by sulfurs or sulfides. In one embodiment, an anti-sulfur agent/anti-sulfide agent isolates silver nanowires from sulfur/sulfide pollutants. In another embodiment, an anti-sulfur agent/anti-sulfide agent isolates silver nanowires from sulfur/sulfide pollutants through the use of a coating agent on the surface of the silver nanowires. In one embodiment, the anti-sulfur agent/anti-sulfide agent is selected from the group comprising: acrolein, glyoxal, triazine, and n-chlorosuccinimide(NCS). In another embodiment, the concentration of the anti-sulfur agent/anti-sulfide agent is in the range of 1˜500 μM. In another embodiment, the concentration of the anti-sulfur agent/anti-sulfide agent can be in the range of 1 to 30 μM, 30 to 100 μM, 100 to 200 μM, 200 to 300 μM, 300 to 400 μM, 400 to 500 μM, or any combination thereof. In yet another embodiment, the concentration of the anti-sulfur agent may be 3 μM, 30 μM, or 300 μM.

“Noble-metal ion” as used herein, refers to a material selected from the group comprising: gold perchlorate, copper nitrate, cupric oxalate, (hydro)chloroplatinic acid, palladium chloride, diamminedichloropalladium, manganous nitrate, magnesium nitrate, or similar materials. Noble-metal ion may also be referred to as a noble-metal salt. In one embodiment of the present invention, a noble-metal ion can be added after 50-90% of the reaction time of the polyol process is complete. In another embodiment, a noble-metal ion can be added after 80-90% of the reaction time of the polyol process is complete. In still another embodiment, the concentration of the noble-metal ion is in the range of 3-20 mM In another embodiment, the concentration of the noble-metal ion can be in the range of 3-8 mM, 8-12 mM, 12-16 mM, 16-20 mM, or any combination thereof. In yet another embodiment depicted in Figure (h) illustrates a concentration of 0.015 M.

“Sulfhydryl-containing aliphatic compound” as used herein, refers to a sulfhydryl-containing aliphatic compound may be represented by formula HS—R, each R being the same or different and independently an alkyl, alkenyl, alkynyl, aryl, or aralkyl. In one embodiment of the present invention, the addition of one or more sulfhydryl-containing aliphatic compounds takes place after 80˜90% of the total reaction time of the polyol process is complete resulting in the formation of a self-assembled monolayer (SAM) on the surface of the silver nanowires. In another embodiment of the present invention, the concentration of the sulfhydryl-containing aliphatic compound may be in the range of 1˜100 mM. In still another embodiment, the sulfhydryl-containing organic compound is added after 90%˜100% of the total reaction time of polyol process is complete a baking time for generating the self-assembled monolayer coating outside the silver nanowires may be in the range of 1˜3 hours, depending on the type of chemicals applied in a specific recipe. In one embodiment, 60 μM of methanethiol or ethanethiol is added and the baking time is in the range of 30 to 90 minutes, 40 to 80 minutes, 50-70 minutes, or 60 minutes. In another embodiment, 40 μM of propenethiol is added and the baking time is in the range of 90 to 150 minutes, 100 to 140 minutes, 110 to 130 minutes, or 120 minutes. In still another embodiment, 40 μM of phenylmercaptan and toluenethiol are added and the baking time is in the range of 150 to 210 minutes, 160 to 200 minutes, 170 to 190 minutes, or 180 minutes.

“High-valence metal ion” as used herein, refers to magnesium nitrate, manganese nitrate, stannum nitrate, zinc nitrate, iron nitrate, or similar materials. In one embodiment of the present invention, the source of the high-valence metal ion is selected from the group comprising: magnesium nitrate, manganese nitrate, tin nitrate, zinc nitrate, iron nitrate or a combination thereof. In another embodiment of the present invention, the concentration of the high-valence metal ion may be in the range of 1˜150 μM. In another embodiment, the concentration of the high-valence metal ion may be in the range of 1 to 50 μM, 50 to 80 μM, 80 to 100 μM, 100 to 120 μM, 120 to 150 μM, or any combination thereof.

“First seeding step” as used herein, refers to the step of formation of seeds with a stable structure and well-defined crystallinity.

“Acid” as used herein, refers to any compound having a pH lower than 7. The acid compound can be any acid that does not appreciably interfere with the reduction of the silver compound to silver metal or otherwise interfere with the reaction. The acid compound has to be selected to avoid halide ion or iron.

“Nano-seeds”, as used herein, refers to a nano-material which can foster the growth of nanoparticles as described previously.

“Nucleation”, as used herein, refers to the formation of crystals from liquids, or supersaturated solutions. Nucleation occurs when nano-seeds are introduced into a liquid or supersaturated solution. Nanostructures form and grow as nucleation takes place on a nano-seed.

“Second crystal growth step”, as used herein, refers to the growth of five-twinned silver particles formed in the seeding step to silver nanowires in the presence of the template carrier. The second crystal growth step can include heating a solution to a temperature of 120° C., 130° C., 140° C., 150° C., 160° C., or 170° C. for a time period of 16 hours, 14 hours, 12 hours, 10 hours, 8 hours, 6 hours, or any combination thereof.

The shape of a nanocrystal highly depends on the ratio between the areas of crystallographic facets that enclose the nanocrystal. The “template carrier” refers to a chemical agent that can absorb to different facets of the silver surface. This adsorption can significantly affect the relative growth rates of different facets in the solution-phase synthesis induced by the anisotropic growth.

### EMBODIMENTS

In one embodiment, an anti-sulfide agent is added into the polyol process to neutralize the sulfide-related chemicals. The anti-sulfide agent include, but are not limited to: acrolein, glyoxal, triazine, and n-chlorosuccinimide(NCS). The presence of anti-sulfide agent will react with the sulfide-related chemicals, and it will also protect the synthesized wires from further corrosion. However, since the polyol process is a method very sensitive to any kind of the additives or contaminants, a precise control on the dose and the feeding step of anti-sulfide agent is critical to the high quality of the product. The concentration of the anti-sulfide agent is 1˜500 μM. It is added into the solvent (ethylene glycol, EG) of the polyol process, according to the mechanism, n-chlorosuccinimide binds more readily with the sulfide-related corrosive element than with the silver nanowires. N-chlorosuccinimide is known as “scavengers” or “getters”, which compete with the metal and sequester the corrosive elements. In example 1, NCS is added as an anti-sulfide agent in the polyol process, and the resultant product is sulfide-free.

In one embodiment, noble metal salt such as copper, gold, and/or platinum salt-precursors are added to the process which can react with silver nanowires through the galvanic replacement or be reduced by the polyol, forming an alloy layer on the surface of the wire to protect it from further corrosion by the sulfide-related chemicals. It is important to control the dose and the feeding step of the metal salt. The metal salt-precursor is introduced into the reaction after it is 80˜90% finished. For example, to obtain the surface-alloyed silver nanowires, the metal salt-precursors should be fed into the system after the wires can be observed clearly (silvery grey solution with blinking light). The ratio of the added metal salt-precursor to the silver is 1˜50%. Different ratios may exhibit various anti-corrosion effects. In example 2, copper nitrate is added to form an Ag—Cu alloy.

In one embodiment, a sulfhydryl-containing aliphatic compound is added to the later 80˜90% of the total reaction time period of the polyol process which can form a dense self-assembled monolayer (SAM) on the surface of silver nanowires. This SAM can be prior absorbed by the defects where most corrosion starts. The saturated absorption of SAM generates continuous layers on the surfaces of silver nanowires, protecting them from further attraction by the sulfide-related chemicals. The sulfhydryl-containing aliphatic compounds can be Ethanethiol, 1-propanethiol, 2-propanethiol, 3-propanethiol, 1-butanethiol, 2-butanethiol, 3-butanethiol, or 4-butanethiol, and so on. Although most SAM chemicals are insulator materials, the self-assembled monolayer is very thin (at mono-molecular level), and it will thus not reduce the conductivity of the silver-based applications. The SAM chemicals are fed into the reactor after the polyol process reaction is finished or added into the washing step after the polyol process is complete. The critical parameter is temperature. The sulfhydryl-containing aliphatic compound must be introduced into the system with the temperature lower than 40° C. The concentration of the SAM chemical (sulfhydryl-containing aliphatic compound) is 1˜100 mM. In example 6, ethanethiol is added during the silver nanowire production process.

In one embodiment, high-valence metal ions are added to the polyol process which can influence the electric charge distribution on the surface of the silver seeds in the nucleation step, generating a more uniform seed size distribution. The high-valence metal ions can be Mg²⁺, Mn²⁺, Sn²⁺, Zn²⁺, Fe²⁺, Fe³⁺, which can improve the uniformity of the silver nanowires, and obtain higher aspect ratio silver nanowires, and reduce the standard deviation (STDEV) of the silver nanowires. Particularly, the metal ions with variable valence, such as Fe²⁺, Mn²⁺, have more significant effect on improving the uniform size distribution. In examples 8 and 9, Fe(NO₃)₃ and Mg(NO₃)₂ are added during the polyol process, respectively.

In one embodiment, silver chloride (AgCl) and an acid compound are added to the polyol process prior to the addition of silver nitrate. The typical synthesis includes two steps: a seeding step to obtain initial silver seeds followed by a crystal growth step to obtain silver nanowire. In the polyol process, the composition and structure of the initial silver seeds are the critical factors. An AgCl solution is added in the polyol process to form an initial nucleation of the silver seeds. The AgCl solution is prepared by reacting silver nitrate (AgNO₃) with hydrochloric acid (HCl) in equal mole amounts in ethylene glycol (EG). The solubility constant of AgCl in EG is very small at a room temperature. Therefore, there is little free Ag⁺ anion in the solution and almost all Ag⁺ is present as small AgCl nanoparticles. With an increase in the temperature, AgCl is dissolved gradually in the EG and Ag⁺ and Cl⁻ are released to the reaction solution, which supply reducing materials to the neutral Ag. This provides small Ag nanoparticles in EG in the high temperature region. The AgNO₃ solution is then added into the reaction system drop-by-drop, leading to the nucleation and growth of silver nanowires with the assistance of PVP. Here the pre-synthesized Ag nanoparticles serve as seeds for the nucleation and growth of Ag nanowires. Furthermore, in this embodiment, two different heating methods are used in the seeding step and crystal growth step respectively. Generally, the whole polyol process is heated in an oil bath. If the solution is in a flask immersed in the hot oil, the solution always has one interface exposed to the cool air and the other interfaces exposed to the hot flask wall in the oil, so the temperature of the solution is not constant, leading to the silver nanowires having no uniform distribution. In this embodiment, the first step of seeding is heated in an oil bath and the second step of crystal growth is heated at a constant temperature condition to ensure all the interfaces maintain a uniform temperature. The conditions include, but are not limited to: hot oil with a constant temperature, hot vapor with a constant temperature, hot air with a constant temperature, and hot nitrogen with a constant temperature. In example 10, an AgCl solution and nitric acid are added in the polyol process and the second step of crystal growth is heated by hot air in an hot oven.

One embodiment of the present invention includes a method for the production of silver nanowire comprising the steps of: heating a first solution comprising a polyol and a salt; adding a second solution comprising a polyol and a silver nitrate; adding a third solution comprising a polyol and an organic polymer as a template carrier creating a combined solution; stirring the combined solution at an elevated temperature for a time period followed by cooling the combined solution; and washing the combined solution and isolating the silver nanowires. The embodiment may further include the addition of one or more halide during the production of silver nanowires. The halide may be selected from the group including, but not limited to, sodium chloride, potassium chloride, sodium bromide, potassium bromide, sodium iodide, potassium iodide, lithium chloride, lithium bromide, lithium iodide, tetrabutylammonium chloride(TBAC), tetrabutyl ammonium bromide(TBAB), cetyltrimethyl Ammonium Bromide(CTAB), or a combination thereof.

In another embodiment of the above method, an anti-sulfur agent and a noble-metal salt may be used together in the production of silver nanowires.

One embodiment of the present invention includes a method for the production of silver nanowire comprising the steps of: a first seeding step including heating a first solution comprising a polyol, a salt and an organic polymer as a template carrier; adding an acid followed by the addition of a silver chloride solution resulting in a second solution containing nano-seeds for initial nucleation; a second crystal growth step including heating the second solution to a temperature for a period of time to ensure growth of the silver nanowires from the nano-seeds; cooling the second solution; and washing the second solution and isolating the silver nanowires. The above method is for the production of silver nanowires having a uniform size distribution and a high aspect ratio. The embodiment may further include the addition of one or more halide during the production of silver nanowires. The halide may be selected from the group including, but not limited to, sodium chloride, potassium chloride, sodium bromide, potassium bromide, sodium iodide, potassium iodide, lithium chloride, lithium bromide, lithium iodide, tetrabutylammonium chloride (TBAC), tetrabutyl ammonium bromide (TBAB), cetyltrimethyl Ammonium Bromide (CTAB), or a combination thereof.

### EXAMPLES

### A. Addition of N-Chlorosuccinimide (NCS) as an Anti-Sulfide Agent in the Synthesis of Silver Nanowires.

### Example 1

A solution of 1000 ml of ethylene glycol containing 0.02 g NaCl was first immersed and then heated in an oil bath set to 150° C. for 60 minutes. Two constant pressure funnels were then utilized for the simultaneous injection of two additional 1000 ml ethylene glycol (EG) solutions into the hot EG solution at a rate of 100 ml/min. The first solution contained 100 mM of silver nitrate, and the second solution contained 300 mM poly(vinyl pyrrolidone) (PVP, Mw=55000). Mechanical stirring was applied throughout the entire nanowire synthesis. The reaction was carried out for 100 minutes at 150° C. after which the hot EG solution was cooled to room temperature. The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). Figure (a) is a TEM picture of materials produced following the method set out in Example 1. Figure (b) is a sulfur map created using Energy Filtered Transmission Electron Microscopy (EFTEM) of materials produced following the method set out in Example 1. Figure (c) is a spectrogram of one small zone of figure (a).

### Example 2

0.003 g NCS was added to 3000 ml of ethylene glycol (EG), and then blended until it fully dissolved resulting in a solution. The ethylene glycol solution containing trace amount of NCS was then used for the preparation of silver nitrate and poly(vinyl pyrrolidone) solutions. The first solution contained 100 mM silver nitrate, and the second solution contained 300 mM polyvinyl pyrrolidone) (PVP, Mw=55000). A solution of 1000 ml of EG containing trace amount of NCS and 0.02 g NaCl was first immersed and then heated in an oil bath set to 150° C. for 60 min. Two constant pressure funnels were utilized for the preservation and storage of the silver nitrate and PVP solutions which were then utilized for the simultaneous injection of the first 1000 ml EG solution containing 100 mM of silver nitrate and the second 1000 ml EG solution containing 300 mM PVP into the hot EG solution at a rate of 100 ml/min. Mechanical stirring was applied throughout the entire nanowire synthesis. The reaction was carried out for 100 minutes at 150° C. after which the hot EG solution was cooled to room temperature. The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). Figure (d) is a TEM picture of materials produced following the method set out in Example 2. Figure (e) is a sulfur map created using EFTEM of materials produced following the method set out in Example 2.

### Example 3

Example 3 followed the same steps as laid out in Example 2 above with the exception that the amount of NCS was changed to 0.03 g. After the washing process, the sample was dispersed in ethanol for further characterization utilizing transmission electron microscopy (TEM). Figure (f) is a TEM picture of materials produced following the method set out in Example 3.

### Example 4

Example 4 followed the same steps as laid out in Example 2 above with the exception that the amount of NCS was changed to 0.3 g. After the washing process, the sample was dispersed in ethanol for further characterization utilizing transmission electron microscopy (TEM).Figure (g) is a TEM picture of materials produced following the method set out in Example 4.

### B. Addition of Copper Nitrate to Form an Ag—Cu Alloy

### Example 5

A solution of 1000 ml of ethylene glycol (EG) containing 0.02 g NaCl was first immersed and then heated in an oil bath set to 150° C. for 60 minutes. Two constant pressure funnels were then utilized for the simultaneous injection of two additional 1000 ml EG solutions into the hot EG solution at a rate of 100 ml/min. The first solution contained 100 mM of silver nitrate, and the second solution contained 300 mM poly(vinyl pyrrolidone) (PVP, Mw=55000). Mechanical stirring was applied throughout the entire nanowire synthesis. The reaction was carried out for 90 minutes at 150° C. at which point 300 ml of EG solution containing 100 mM of copper nitrate was added to the hot EG solution. The reaction then continued for an additional 10 minutes after which the hot EG solution was cooled to room temperature. The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). Looking at the TEM studies, it is clearly demonstrated that the Ag—Cu alloy resulting from the above process reduces the presence of the silver sulfide nanoparticles on the surface of the silver nanowires. Such products also show better performance in the anti-sulfide EFTEM testing and EDX elemental analysis. Figure (h) is a TEM picture of materials produced following the method set out in Example 5. Figure (i) is a spectrogram of one small zone of figure (h). This strategy can be applied to most silver nanowires production processes.

C. Addition of ethanethiol

### Example 6

A solution of 1000 ml of ethylene glycol (EG) containing 0.02 g NaCl was first immersed and then heated in an oil bath set to 150° C. for 60 minutes. Two constant pressure funnels were then utilized for the simultaneous injection of two additional 1000 ml EG solutions into the hot EG solution at a rate of 100 ml/min. The first solution contained 100 mM of silver nitrate, and the second solution contained 300 mM poly(vinyl pyrrolidone) (PVP, Mw=55000). Mechanical stirring was applied throughout the entire nanowire synthesis. The reaction was carried out for 80 minutes at 150° C. at which point 30 ml of ethanethiol was added to the hot EG solution. The reaction then continued for an additional 30 minutes after which the hot EG solution was cooled to room temperature. The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). The TEM data clearly demonstrates that the amount of short nanowires produces is significantly reduced and that the nanowires are sulfide-free. Such products also show better performance in the anti-sulfide EFTEM testing and EDX elemental analysis. Figure (j) and figure (l) are TEM pictures of materials produced following the method set out in Example 6. Figure (k) is a spectrogram of one small zone of figure (j). This strategy can be applied to most silver nanowire production processes.

### D. Addition of High-Valence Metal Ions

### Example 7

A solution of 1000 ml of ethylene glycol (EG) containing 0.02 g NaCl was first immersed and then heated in an oil bath set to 150° C. for 60 minutes. Two constant pressure funnels were then utilized for the simultaneous injection of two additional 1000 ml EG solutions into the hot EG solution at a rate of 100 ml/min. The first solution contained 100 mM of silver nitrate, and the second solution contained 300 mM poly(vinyl pyrrolidone) (PVP, Mw=55000). Mechanical stirring was applied throughout the entire nanowire synthesis. The reaction was carried out for 100 minutes at 150° C. after which the hot EG solution was cooled to room temperature. The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). Figure (m) is a TEM picture of materials produced following the method set out in Example 7.

### Example 8

A solution of 1000 ml of ethylene glycol (EG) containing 0.02 g NaCl was first immersed and then heated in an oil bath set at 150° C. for 60 minutes. Two constant pressure funnels were then utilized for the simultaneous injection of two additional 1000 ml EG solutions into the hot EG solution at a rate of 100 ml/min. The first solution contained 100 mM of silver nitrate, and the second solution contained 300 mM poly(vinyl pyrrolidone) (PVP, Mw=55000) and 0.019 g of Fe(NO₃)₃. Mechanical stirring was applied throughout the entire nanowire synthesis. The reaction was carried out for 100 minutes at 150° C. after which the hot EG solution was cooled to room temperature. The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). Figure (n) is a TEM picture of materials produced following the method set out in Example 8.

### Example 9

A solution of 1000 ml of ethylene glycol (EG) containing 0.02 g NaCl was first immersed and then heated in an oil bath set to 150° C. for 60 minutes. Two constant pressure funnels were then utilized for the simultaneous injection of two additional 1000 ml EG solutions into the hot EG solution at a rate of 100 ml/min. The first solution contained 100 mM of silver nitrate, and the second solution contained 300 mM poly(vinyl pyrrolidone) (PVP, Mw=55000) and 0.012 g of Mg(NO₃)₂. Mechanical stirring was applied throughout the entire nanowire synthesis. The reaction was carried out for 100 minutes at 150° C. after which the hot EG solution was cooled to room temperature (˜20-25° C.). The resulting suspension samples were first washed with ethanol and then with water to remove most of the EG and the PVP. During the washing process, the suspension was centrifuged at 4000 rpm for 10 minutes after washing with ethanol and then centrifuged at 4000 rpm for 30 minutes after washing with water to ensure that most of the silver nanoparticles taken from the reaction were recovered. Finally, the sample was dispersed in ethanol for further characterization utilizing transmission electron microscopy (TEM). Figure (o) is a TEM picture of materials produced following the method set out in Example 9.

E. Addition of AgCl Solution and Nitric Acid in the Polyol Process and Heating the Second Crystal Growth Step by Hot Air under a Consistent Temperature.

### Example 10

For the first seeding step, a mixture of 70 g of poly vinylpyrrolidone (PVP, Mw=55000), 0.7 g of sodium bromide (NaBr), and 2700 ml of ethylene glycol (EG) was heated and thermally stabilized at 150° C. in a flask. Next, 0.5 ml of nitric acid was added and the mixture was set aside for 5 minutes. A 900 ml solution comprising 1.5 g AgCl prepared by reacting equal mole amounts of silver nitrate with hydrochloric acid in EG was then added to the flask for initial nucleation of the silver seeds. After 3 minutes, a solution of 19 g of silver nitrate in 900 ml EG was titrated for 10 minutes.

For the second crystal growth step, the flask was moved to an oven set to 160° C. and then heated for 3 hours to ensure that the growth was complete. The solution was then cooled to room temperature, washed with ethanol and then with water to remove most of the EG and the PVP. After the washing process, the sample was dispersed in ethanol for further characterization utilizing transmission electron microscopy (TEM). Figure (p) is a TEM picture of materials produced following the method set out in Example 10. The silver nanowire produced had a mean diameter of 36.1±5.5 nm, and an average length of 23.4±8.5 μm. There were very few nanoparticles formed.

The present invention may be embodied in other forms without departing from the spirit and the essential attributes thereof, and, accordingly, reference should be made to the appended claims, rather than to the forgoing specification, as indicated in the scope of the invention. The invention illustratively disclosed herein suitably may be practiced in the absence of any element which is not specifically disclosed herein.

1. A method for the production of silver nanowire comprising the steps of:
heating a first solution comprising a polyol and a salt;
adding a second solution comprising a polyol and a silver nitrate;
adding a third solution comprising a polyol and an organic polymer as a template carrier creating a combined solution;
stirring the combined solution at an elevated temperature for a time period followed by cooling the combined solution; and
washing the combined solution and isolating the silver nanowires from the combined solution.

2. The method of claim 1, further comprising the addition of one or more anti-sulfur agents/anti-sulfide agents.

3. The method of claim 2, wherein the anti-sulfur agent/anti-sulfide agent is selected from the group comprising: acrolein, glyoxal, triazine, and n-chlorosuccinimide (NCS).

4. The method of claim 3, wherein the concentration of anti-sulfur agent/anti-sulfide agent is in the range of 1˜500 μM.

5. The method of claim 1, wherein the polyol is selected from the group comprising: ethylene glycol, 1,2-propylene glycol, 1,3-propylene glycol, glycerin, and glycerol, or a combination thereof; and
wherein the salt is selected from the group comprising: sodium chloride, potassium chloride, sodium bromide, potassium bromide, sodium iodide, potassium iodide, lithium chloride, lithium bromide, lithium iodide, tetrabutylammonium chloride (TBAC), tetrabutyl ammonium bromide (TBAB), cetyltrimethyl Ammonium Bromide (CTAB), or a combination thereof.

6. The method of claim 1, wherein the template carrier is selected from the group comprising: a polyvinylpyrrolidone (PVP) or a polyvinyl alcohol (PVA).

7. The method of claim 1, further comprising the addition of a noble-metal ion after 50-90% of the total reaction time of the nanowire production process is complete.

8. The method of claim 7, wherein the noble metal ion is selected from the group comprising: gold perchlorate, copper nitrate, cupric oxalate, (hydro)chloroplatinic acid, palladium chloride, diamminedichloropalladium, manganous nitrate, magnesium nitrate or a combination thereof.

9. The method of claim 8, wherein the concentration of the noble-metal ion is in the range of 3˜20 mM.

10. The method of claim 9, further comprising the addition of a noble-metal ion after 80-90% of the total reaction time of the polyol process is complete.

11. The method of claim 1, further comprising the addition of one or more sulfhydryl-containing aliphatic compounds after 80˜90% of the total reaction time of the polyol process is complete resulting in the formation of a self-assembled monolayer (SAM) on the surface of the silver nanowires.

12. The method of claim 11, wherein the sulfhydryl-containing aliphatic compound is represented by formula HS—R, each R being the same or different and independently an alkyl, alkenyl, alkynyl, aryl, or aralkyl.

13. The method of claim 12, wherein the concentration of the sulfhydryl-containing aliphatic compound is in the range of 1˜100 mM.

14. The method of claim 11, wherein the sulfhydryl-containing aliphatic compound is added after 90%˜100% of the total reaction time of polyol process is complete followed by a baking time for generating the self-assembled monolayer coating outside the silver nanowires.

15. The method of claim 1, further comprising the addition of one or more high-valence metal ion.

16. The method of claim 15, wherein the source of the high-valence metal ion is selected from the group comprising: magnesium nitrate, manganese nitrate, tin nitrate, zinc nitrate, iron nitrate or a combination thereof.

17. The method of claim 15, wherein the concentration of the high-valence metal ion is in the range of 1˜150 μM.

18. A method for the production of silver nanowire comprising the steps of:
a first seeding step including heating a primary solution comprising a polyol, a salt and an organic polymer as a template carrier;
adding an acid followed by the addition of a silver chloride solution resulting in a secondary solution containing nano-seeds for initial nucleation;
a second crystal growth step including heating the secondary solution to a temperature for a period of time to ensure growth of the silver nanowires from the nano-seeds;
cooling the secondary solution; and
washing the secondary solution and isolating the silver nanowires.

19. The method of claim 18, wherein the polyol is selected from the group comprising: ethylene glycol, 1,2-propylene glycol, 1,3-propylene glycol, glycerin, and glycerol, or a combination thereof;
wherein the salt is selected from the group comprising: sodium chloride, potassium chloride, sodium bromide, potassium bromide, sodium iodide, potassium iodide, lithium chloride, lithium bromide, lithium iodide, tetrabutylammonium chloride(TBAC), tetrabutyl ammonium bromide(TBAB), cetyltrimethyl Ammonium Bromide(CTAB), or a combination thereof;
wherein the template carrier is a polyvinylpyrrolidone(PVP) or a polyvinyl alcohol (PVA);
wherein the acid is selected from the group comprising: nitric acid, nitrous acid, acetic acid, perchloric acid, or hydrochloric acid;
wherein the silver chloride solution is prepared by reacting AgNO₃ with hydrochloric acid in equal mole amounts within ethylene glycol; and
wherein the second crystal growth step is carried out at a constant temperature condition, the condition includes, but are not limited to: hot oil with a constant temperature, hot air with a constant temperature, hot nitrogen with a constant temperature, or a combination thereof.

20. The method of claim 19, wherein the temperature of the second crystal growth step include, but are not limited to: 120° C., 130° C., 140° C., 150° C., 160° C., 170° C.; and wherein the period of time for the second crystal growth step is in the range of 6 to 16 hours.
